(19) United States
(12) Patent Application Publication
(10) Pub. No.: US 2014/0285023 A1
(43) Pub. Date: Sep. 25, 2014

(54) SOLAR POWER SYSTEMS INCLUDING CONTROL HUBS

(71) Applicant: SunEdison LLC, Beltsville, MD (US)

(72) Inventors: Gopal K. Garg, Fremont, CA (US); Binod Kumar Agrawal, Sadabad (IN); Stephen J. Voss, Louisville, CO (US)

(21) Appl. No.: 14/116,050

(22) PCT Filed: May 4, 2012
(86) PCT No.: PCT/US2012/036547

§ 371 Date: May 8, 2014

Related U.S. Application Data
(60) Provisional application No. 61/483,596, filed on May 6, 2011.

(51) Int. Cl. H02J 4/00

(52) U.S. Cl. CPC H02J 4/00
USPC 307/82

(57) ABSTRACT

Control hubs and solar power systems are disclosed. One example photovoltaic (PV) system includes a plurality of PV modules and a control hub coupled to the plurality of PV modules. The control hub includes a plurality of interface modules and a processing device coupled to the interface modules. Each of the interface modules includes a power converter coupled to a different one of the plurality of PV modules. The processing device is configured to control each of the power converters to control the PV module associated with the power converter.

### CROSS-REFERENCE TO RELATED APPLICATIONS

This application claims priority to U.S. Provisional Application No. 61/483,596 filed May 6, 2011, the entire disclosure of which is hereby incorporated by reference in its entirety.

### FIELD

The present disclosure relates generally to solar power systems (also referred to as photovoltaic systems), and more particularly, to control hubs for coupling to a plurality of photovoltaic modules.

### BACKGROUND

This section provides background information related to the present disclosure which is not necessarily prior art.

A wide variety of photovoltaic (PV) modules are known to utilize solar energy from the sun to generate electrical energy. The PV modules often include a solar energy absorption board, a junction box for connecting to other PV modules, a controller, and a power storage unit, such as a battery. The controller generally includes maximum power point tracking (MPPT) functionality to deliver maximum available power to the storage unit. The junction box and the controller are known to be mounted within a frame of the PV module. Multiple PV modules may be organized into an array, with each PV module including a controller, to provide an increased power output.

### SUMMARY

This section provides a general summary of the disclosure, and is not a comprehensive disclosure of its full scope or all of its features.

According to one aspect of the present disclosure, a photovoltaic (PV) system is disclosed. The PV system includes a plurality of PV modules and a control hub coupled to the plurality of PV modules. The control hub includes a plurality of interface modules and a processing device coupled to the interface modules. Each of the interface modules includes a power converter coupled to a different one of the plurality of PV modules. The processing device is configured to control each of the power converters to control the PV module associated with the power converter.

According to another aspect of the present disclosure, a control hub for a photovoltaic (PV) system including a plurality of PV modules is described. The control hub includes a plurality of interface modules and a processing device coupled to the interface modules. Each of the plurality of interface modules includes a power converter and a connector. The connector is coupled to the power converter and configured for coupling to a PV module. The processing device is configured to control each of the power converters to control a PV module associated with said power converter.

Further areas of applicability will become apparent from the description provided herein. The description and specific examples in this summary are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagram of a photovoltaic (PV) system according to one example embodiment of the present disclosure.

FIG. 2 is a block diagram of a portion of the PV system of FIG. 1.

FIG. 3 is a block diagram of a PV system according to another example embodiment.

Corresponding reference numerals indicate corresponding parts throughout the drawings.

### DETAILED DESCRIPTION

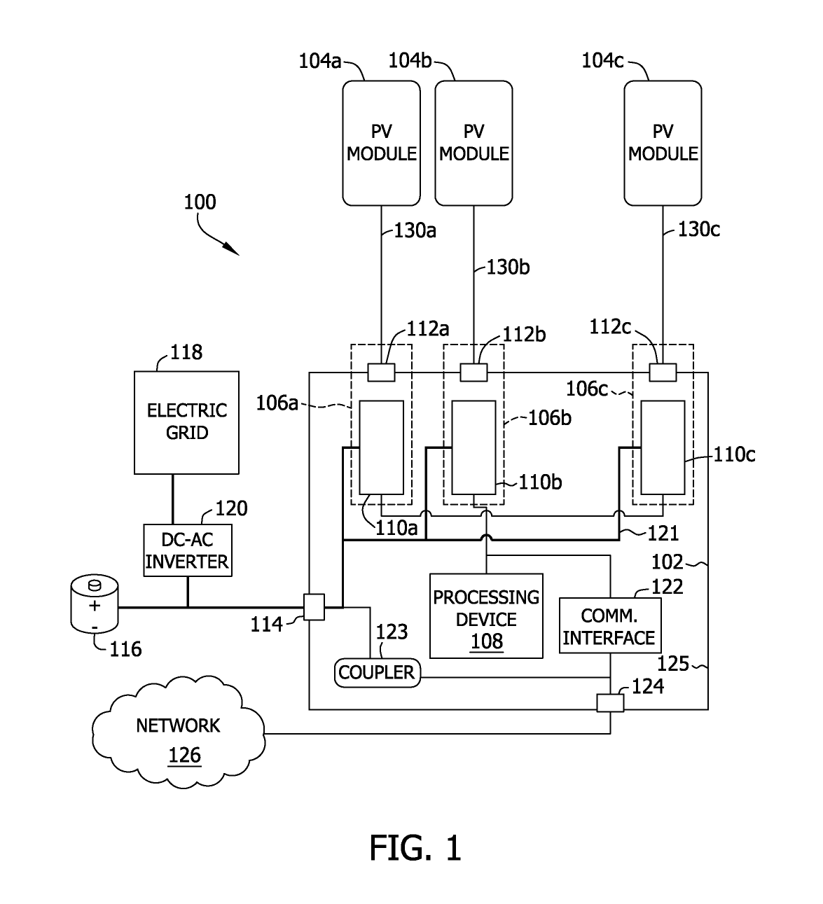

According to one embodiment, a solar power system (also referred to as a photovoltaic system) is illustrated in FIG. 1 and generally referenced 100. The solar power system 100 includes a control hub 102 and a string of photovoltaic (PV) modules 104a-104c (generally referred to as PV modules 104). Each of the PV modules 104 is configured to convert solar energy into direct current (DC) electrical energy. As known to those skilled in the art, electrical energy is produced by each of the PV module 104 according to a current-voltage curve. The current-voltage curve defines a maximum power point (MPP) at which each of the PV modules 104 is operating at maximum power under particular conditions, such as shading, dirt, etc.

In the exemplary embodiment, the control hub 102 includes a plurality of interface modules 106a-106c (generally referred to as interface modules 106). Each of the interface modules 106 includes a power converter 110a-110c (generally referred to as power converters 110) and a connector 112a-112c coupled to a respective one of the PV modules 104. The control hub 102 includes a processing device 108 coupled to all of the interface modules 106 to control each of the power converters 110.

Each power converter 110 may include any suitable circuit for converting the DC voltage supplied from the PV modules 104 into a desired voltage and/or current. For example, power converters 110 may include a buck converter, a boost converter, a buck/boost converter, a charge balancer, and/or a power balancer, etc. In this particular embodiment, each of the power converters 110 includes a buck converter.

In use, the power converters 110 buck the DC voltage supplied from the PV modules 104 to a desired voltage. Each of the power converters 110 is individually controlled by processing device 108 to control the associated PV module 104. More specifically, in this particular embodiment, the processing device 108 is configured to control the power converters 110 to substantially achieve MPPT in the associated PV module 104. As a result, a single control hub 102 may be employed to adjust and/or maximize electrical energy delivered from a plurality of PV modules 104. In this manner, the control hub 102 may replace individual MPPT controllers associated with each of multiple PV modules, without reduced functionality. As such, the control hub 102 described herein may provide cost savings, due to reduction in the number of communication links, processing devices, power supplies, housings, and/or cables, etc. The reduction and/or elimination of controllers at each of the individual PV module may further provide efficiencies in production and/or testing of the PV modules. Additionally, or alternatively, a solar power system as described herein may provide efficiencies for service and/or upgrades by providing a single control hub for performing various functions associated with multiple PV modules.

The processing device 108 may control power converters 110 in any suitable manner. In this particular embodiment, the processing device 108 employs a time multiplexed maximum power point tracking (MPPT) to ensure each of the individual PV modules 104 is operating at or substantially close to its MPP. Specifically, processing device 108 sequentially interrogates each of the interface modules 106 to determine if each of the PV modules 104 is operating within a desired range. If one or more of the PV modules 104 is outside the desired range, the processing devices 108 communicates with the associated interface module 106, specifically the associated power converter 110, to alter operation of the interface module 106. The processing device 108 periodically polls each of the interface modules 106 to ensure operation of the PV modules 104 within the desired range over time.

Each of the interface modules 106 provides an output to a DC voltage bus 121. The voltage bus 121 is coupled to output connector 114 to supply a power output from control hub 102. More specifically, each of the power converters 110 is connected in series to provide a total power output to the connector 114, which is substantially equal to the sum of the outputs of the individual interface modules 106. For example, if each of power converters 110 generates a 40VDC output voltage, the total output voltage of the control hub 102 is substantially equal to about 120VDC.

It should be appreciated that a different number of interface modules 106 and/or PV modules 104 may be included in other embodiments. The number of interface modules 106 and/or PV modules 104 may be selected potentially based on a power requirement of a solar power system. For example, a different number of interface modules 106 and PV modules 104 may be included to provide a voltage output of 600VDC, 1000VDC, or other voltage/current requirement. Additionally, or alternatively, multiple solar power systems may be coupled together to achieve a power requirement. In one exemplary embodiment, a control hub 102 may include fifteen interface modules 106 coupled to fifteen PV modules 104; each interface module providing 40VDC. A series connection of the interface modules 106 provides an output voltage of 600VDC. As should be apparent, because each of the PV modules 104 only provides 40VDC, each individual interface module 106 is connected across 40VDC, rather than the 600VDC high-voltage output of the control hub 102.

The output connector 114 may be coupled to an energy storage device 116, an electric grid 118, and/or both to supply electrical energy from the PV modules 104. The energy storage device 116 may include, without limitation, one or more batteries, capacitors, or other suitable devices for storing electrical energy. When coupled to the electric grid 118, the control hub 102 may be coupled to the electric grid via a DC-AC inverter 120. The DC-AC inverter 120 may be suitable to generate any AC voltage from the total voltage output supplied from the control hub 102 at connector 114. In at least one embodiment, the design of the DC-AC inverter 120 may be simplified based on a substantially known, fixed voltage provided from the control hub 102. Further, in various embodiments, the control hub 102 may be configured to avoid negative interactions between the power converters 110 and the DC-AC inverter 120, such as a race condition, etc.

In at least one embodiment, one or more inverter may be incorporated into a control hub. More specifically, a DC-AC inverter may be included in interface modules 106 to provide an AC output at the module-level or connected between DC voltage bus 121 and the output connector 114 to provide an AC output at the hub-level. Such an inverter may include a micro inverter, a string inverter or other suitable inverter, etc.

As illustrated in FIG. 1, the control hub 102 includes a communication interface 122 and a network connector 124. The communication interface 122 is coupled to the processing device 108 to provide communication, via network connector 124, to and/or from a network 126. The network 126 may include a WAN, a LAN, a wired network, a wireless network, and/or a cellular network, etc. The control hub 102 may be able to communicate to and/or from other devices in communication with the network 126. In this particular embodiment, the control hub 102 includes a coupler 123 coupled between the communication interface 122 and the DC voltage bus 121. The coupler 123 is configured to interact with the DC voltage bus 121 to provide power line communication to and/or from the control hub 102. In such an embodiment, the network 126 includes the electric grid 118.

The processing device 108 is configured to monitor one or more operating parameters of the control hub 102. Moreover, the processing device 108 is configured to monitor and/or receive one or more operating parameters from each of the PV modules 104. Operating parameters may include, without limitation, voltages, currents, temperatures, orientation of the PV module 104, etc. Accordingly, the processing device 108, in combination with communication interface 122, may provide system monitoring, via network 126, at the module-level and/or the hub-level. Additionally, or alternatively, the processing device 108 may receive one or more commands from another device in communication with network 126. Specifically, for example, the processing device 108 may be commanded by a user to reduce total power output of the solar power system 100 and/or to shut down the solar power system 100.

In addition to controlling interface modules 106, various other functions may be performed by the processing device 108. For example, the processing device 108 may be configured to monitor temperatures conditions, control status indicators (e.g., LEDs, etc.), and/or store operating parameters, etc. In at least one embodiment, the processing device 108 may be configured to control the orientation of one or more of the PV modules 104. Specifically, when the PV module 104 is mounted to a trackers system (not shown), the processing device 108 may control the orientation of the PV module 104 to track the sun across the sky. To the extent communication with another device is necessary to efficiently and/or effectively track the sun across the sky, the processing device 108 may utilize communication interface 122. As such, a separate communication channel dedicated to a tracking system may be omitted.

The control hub 102 may be co-located with the PV modules 104 in an outdoor environment, or located remotely from the PV modules 104. The control hub 102 may be mounted on a tracker system, a rack, or other suitable structure proximate to or remote from a string of PV modules. In the exemplary embodiment, the control hub 102 includes an enclosure 125 for enclosing the processing device 108, the communication interface 122, and power converters 110. The enclosure 125 may be structured to protect one or more components of the control hub 102 from moisture, dust, debris, and/or weather conditions, etc. As shown in FIG. 1, connectors 112 are substantially included within the enclosure 125, yet still accessible for coupling to the PV modules 104. The connectors 112 may be any suitable type of connectors for coupling to one of the PV modules to the respective power converter. For example, connectors 112 may include MC3 connectors, MC4 connectors, and/or other suitable connectors.

The processing device 102 may include, without limitation, one or more central processing units, microprocessors, microcontrollers, logic devices, application specific integrated circuits (ASIC), programmable gate arrays, and any other device capable of operating as described herein.

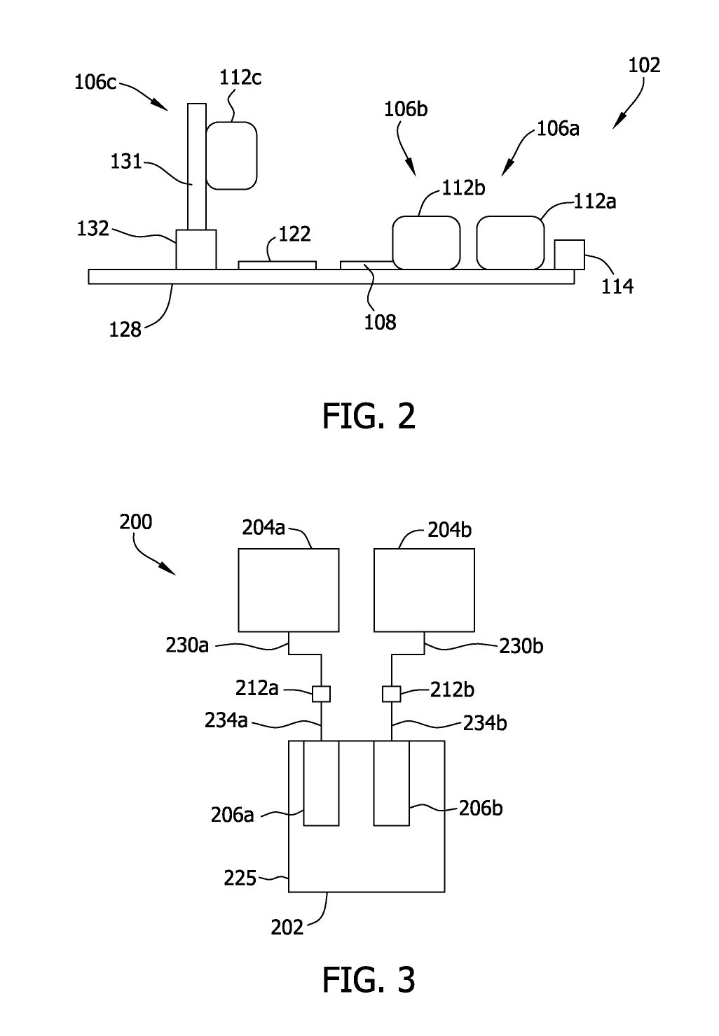

FIG. 2 illustrates the control hub 102 (without enclosures 125). As shown, the control hub 102 includes a main printed circuit board (PCB) 128. The processing device 108 and the communication interface 122 are coupled to the main PCB 128. Further, interface modules 106a and 106b are coupled to the main PCB 128. Specifically, power converters 110a and 110b (not shown) and connectors 112a and 112b are soldered and/or otherwise substantially permanently connected to the main PCB 128. In contrast, interface module 106c includes a module PCB 131. The module PCB 131 is structured to be plugged into a connector 132 of PCB 128. When interface module 106c is plugged into connector 132, the interface module 106c is electrically coupled to the processing device 108 and interface modules 106a and 106b.

In this manner, the interface module 106C is removable from control hub 102. As a result, the interface module 106c may be removed for maintenance, replacement, and/or upgrade with minimal impact on the control hub 102. Further, when interface module 106c is plugged into connector 132, processing device 108 may automatically recognize the addition of the interface module 106c and adjusts its operation accordingly. Conversely, when interface module 106c is removed from connector 132, processing device 108 may automatically recognize the removal of the interface module 106c and adjusts its operation accordingly.

It should be appreciated that any number of interface modules 106 may be included in other control hub embodiments. Some or all of the interface modules 106 may be releasably received therein, consistent with interface module 106c. Additionally, or alternatively, some or all of the interface modules 106 may be substantially permanently fixed within the control hub, consistent with interface modules 106a and 106b.

FIG. 3 illustrates a solar energy system 200 according to another exemplary embodiment. The solar power system includes control hub 202 and a string of PV modules 204a and 204b (generally referred to as PV modules 204). The control hub 202 includes multiple pigtails 234a and 234b (generally referred to as pigtails 234) extending from an enclosure 225. One end of pigtails 234 are terminated outside enclosure 225 at connectors 212a and 212b (generally connectors 212). The other end of pigtails 234 are terminated within the enclosure 225 of the control hub 202 to provide electrical power from PV modules 204 to the respective interface modules 206a and 206b (generally referred to as interface modules 206). In one example embodiment, the pigtails 234 may be four (4) to twelve (12) inches in length or another length to permit efficient coupling between connectors 212 and the PV modules 204. The pigtails 234 may be terminated (e.g., soldered, crimped, etc.) at a main PCB (not shown) of the control hub 202 or a module PCB (not shown) of the interface modules 206. In this particular embodiment, each pigtail 234 is soldered to a module PCB of the respective interface modules 206. The module PCBs each include a power converter, consistent with the description above.

It should be appreciated that cables 130 of FIG. 1, cables 230, and/or pigtails 234 of FIG. 3 may include AWG10 wires, AWG12 wires, AWG14 wires, or other thickness of wire of sufficient capacity to handle electrical energy supplied from the PV modules 104 or 204 to the control hub 102 or 202.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A photovoltaic (PV) system comprising:
a plurality of PV modules; and
a control hub including:
a plurality of interface modules, each of the plurality of interface modules including a power converter coupled to a different one of the plurality of PV modules; and
a processing device coupled to the interface modules, the processing device configured to control each of the power converters to control the PV module associated with said power converter.

2. The PV system of claim 1, wherein the processing device is configured to individually control each of the power converters to substantially achieve a maximum power point for the PV module associated with said power converter.

3. The PV system of claim 1, wherein the processing device is configured to sequentially control each power converter of the plurality of interface modules.

4. The PV system of claim 1, wherein each power converter includes at least one of a boost converter, a buck converter, and a boost-buck converter.

5. The PV system of claim 1, wherein the plurality of PV modules consists of fifteen PV modules and the plurality of interface modules consists of fifteen interface modules.

6. The PV system of claim 1, wherein each of the plurality of interface modules includes a connector coupled to the power converter.

7. The PV system of claim 6, wherein each PV module is coupled to a respective interface module via its associated connector.

8. The PV system of claim 7, further comprising an enclosure at least partially enclosing the plurality of interface modules and the processing device.

9. The PV system of claim 8, further comprising a plurality of pigtails extending from the enclosure, each pigtail including one of the plurality of connectors.

10. The PV system of claim 8, wherein each connector extends from the enclosure.

11. The PV system of claim 1, wherein the control hub further comprises a main circuit board, and wherein the plurality of interface modules and the processing device are mounted to the main circuit board.

12. The PV system of claim 11, further comprising a module printed circuit board (PCB) including one interface module of the plurality of interface modules, the module PCB releasably coupled to a module connector on the main circuit board.

13. The PV system of claim 12, wherein the module connector is communicatively coupled to the processing device.

14. The PV system of claim 1, further comprising a direct current (DC) to alternating current (AC) inverter.

15. A control hub for a photovoltaic (PV) system including a plurality of PV modules, the control hub comprising:
a plurality of interface modules, each of the plurality of interface modules including a power converter and a connector coupled to the power converter and configured for coupling to a PV module; and
a processing device coupled to the interface modules, the processing device configured to control each of the interface modules to control a PV module associated with said power converter.

16. The control hub of claim 15, wherein the processing device is configured to individually control each of the power converters to substantially achieve a maximum power point for a PV module associated with said power converter.

17. The control hub of claim 15, wherein the processing device is configured to sequentially control each power converter of the plurality of interface modules.

18. The control hub of claim 15, wherein each power converter includes at least one of a boost converter, a buck converter, and a boost-buck converter.

19. The control hub of claim 15, further comprising a communication interface configured to facilitate communication between the processing device and a remote computing device.

20. The control hub of claim 15, wherein the plurality of interface modules consists of fifteen interface modules.

21. The control hub of claim 15, further comprising a direct current (DC) voltage bus, wherein an output of each power converter is coupled to the DC voltage bus.

22. The control hub of claim 21, wherein each power converter is configured to receive an input voltage from a PV module via the connector and output an intermediate voltage to the DC voltage bus.

23. The control hub of claim 22, wherein the intermediate voltage is less than the input voltage.

24. The control hub of claim 22, wherein the power converters are coupled to the DC voltage bus in series.

25. The control hub of claim 21, further comprising an output connector coupled to the DC voltage bus to output DC power from the control hub.

26. The control hub of claim 21 further comprising a DC to alternating current (AC) inverter coupled to the DC voltage bus.

27. The control hub of claim 15, further comprising a main circuit board, wherein the plurality of interface modules and the processing device are mounted to the main circuit board.

28. The control hub of claim 27, wherein the main circuit board includes at least one module connector communicatively coupled to the processing device and configured to receive a module printed circuit board (PCB).

29. The control hub of claim 28, further comprising at least one module PCB releasably connected to the module connector, the at least one module PCB including one of the plurality of interface modules.

30. The control hub of claim 15, wherein each interface module comprises a DC to alternating current (AC) inverter.

31. The control hub of claim 15, in combination with a photovoltaic (PV) system including a plurality of PV modules.
